(19) United States
(12) Patent Application Publication
(10) Pub. No.: US 2024/0193441 A1
(43) Pub. Date: Jun. 13, 2024

(54) COMPUTER SYSTEM AND TRAINING DATA GENERATION METHOD

(71) Applicant: Hitachi, Ltd., Tokyo (JP)

(72) Inventor: Terufumi MORISHITA, Tokyo (JP)

(21) Appl. No.: 18/383,427

(22) Filed: Oct. 24, 2023

(30) Foreign Application Priority Data
Dec. 7, 2022 (JP) 2022-195893

(51) Int. Cl. G06N 5/022; G06F 40/58

(52) U.S. Cl. CPC G06N 5/022; G06F 40/58

(57) ABSTRACT

Training data used for training a model that performs a logical inference is generated. A computer system that generates the training data used for training the model configured to perform the logical inference holds argument data representing an argument that leads to a conclusion proposition from a plurality of premise propositions. The proposition is expressed as a logical expression. The computer system searches for the argument data whose conclusion is the premise proposition of the argument data or the argument data whose premise is the conclusion proposition of the argument data and performs combination to generate proof data representing a proof that leads to a conclusion proposition by repeating the argument a plurality of times, converts the proof data into a text expressed as a language expression, and generates the training data using the text.

### CLAIM OF PRIORITY

The present application claims priority from Japanese patent application JP 2022-195893 filed on Dec. 7, 2022, the content of which is hereby incorporated by reference into this application.

### BACKGROUND OF THE INVENTION

### 1. Field of the Invention

The present invention relates to a technique for generating training data used for training a model that simulates human logical inference.

### 2. Description of Related Art

Implementation of artificial intelligence having a human-like logical inference ability has been one of major goals since early days of an artificial intelligence science. If the artificial intelligence having the logical inference ability can be implemented, it is possible to support resolution of complicated decision-making problems occurring in a real world while ensuring transparency and description.

For example, a decision-making problem of “Should we invest in African business?” is considered. To solve the problem, it is necessary to consider argument steps as shown in FIG. 17 one by one.

In general, when only a conclusion of the artificial intelligence is presented, it is difficult for a person to accept the conclusion with a sense of satisfaction. Here, by presenting a thinking process as shown in FIG. 17 in addition to the conclusion, the transparency and the description can be ensured. Ensuring the transparency and the description can increase a tracking possibility 4 error caused by the artificial intelligence, which leads to more accurate decision-making.

An inference that leads to a conclusion from a premise proposition (statement) is recognized as an appropriate inference. Such a type of logical inference is referred to as an argument, and is formulated in a format as shown in FIG. 18. An inference in which an argument is repeated a plurality of times to lead to a conclusion is called a proof.

Here, the following facts are known in logic.

(1) The logical inference is to generate a proof of a logical expression by repeating a symbol modification (argument) according to a certain rule.

(2) Validity of the logical inference does not depend on a content of a proposition but depends only on a format.

(3) The logical expression (conclusion) derived by the logical inference is always a logical truth, and all logical truths can be derived by a deduction inference.

To implement the artificial intelligence having the logical inference ability, training data for simulating the logical inference may be created, and training may be performed using the training data. Since the logical inference is to generate a proof by repeating the argument, it is necessary to generate a text representing the proof to generate the training data for simulating the logical inference.

Examples of studies for generating such training data include NPLs 1 and 2. In NPL 1, various logical expressions are randomly generated, and a logical inference solver is applied to the logical expressions to generate a proof. In NPL 2, a proof process is generated by randomly converting a premise and a conclusion of a manually prepared argument into an appropriate natural language.

### CITATION LIST

### Non Patent Literature

NPL 1: Tafjord, Oyvind, Bhavana Dalvi Mishra, and Peter Clark, “ProofWriter: Generating implications, proofs, and abductive statements over natural language.” [online], Dec. 24, 2020, [searched on Nov. 21, 2022], Internet <URL: https://arxiv.org/abs/2012.13048v1>
NPL 2: Gregor Betz, Christian Voigt, and Kyle Richardson. 2021. “Critical Thinking for Language Models.”, In Proceedings of the 14th International Conference on Computational Semantics (IWCS), pages 63-75, Groningen, The Netherlands (online). Association for Computational Linguistics.

### SUMMARY OF THE INVENTION

In NPL 1, an argument in a corpus cannot be designated, and only a simple proof having a small number of steps of proof can be generated. In NPL 2, only a single argument is handled, and stacking of the arguments is not handled.

An object of the invention is to generate, based on a proof that leads to a conclusion by repeating a non-biased argument a plurality of times, training data used for training a model that performs a logical inference.

A representative example of the invention disclosed in the present application is as follows. That is, a computer system for generating training data used for training a model configured to perform a logical inference includes at least one computer, in which the computer system holds argument data representing an argument that leads to a conclusion proposition from a plurality of premise propositions, the proposition is expressed as a logical expression, and the at least one computer searches for the argument data whose conclusion is the premise proposition of the argument data or the argument data whose premise is the conclusion proposition of the argument data and performs combination to generate proof data representing a proof that leads to a conclusion proposition by repeating the argument a plurality of times, converts the proof data into a text expressed as a language expression, and generates the training data using the text.

According to the invention, it is possible to generate, based on a proof in which a non-biased argument is repeated a plurality of times, training data used for training the model that performs a logical inference. Problems, configurations, and effects other than those described above will be clarified by description of the following embodiments.

### BRIEF DESCRIPTION OF THE DRAWINGS

FIG. 1 is a diagram showing an example of a configuration of a computer according to Embodiment 1;

FIG. 2A is a diagram showing an example of argument data stored in an argument data database according to Embodiment 1;

FIG. 2B is a diagram showing an example of the argument data stored in the argument data database according to Embodiment 1;

FIG. 3 is a diagram showing an example of a translation template database according to Embodiment 1;

FIG. 4 is a flowchart showing an example of training data generation processing executed by the computer according to Embodiment 1;

FIG. 5 is a flowchart showing an example of proof tree generation processing executed by a proof tree generation unit according to Embodiment 1;

FIG. 6 is a diagram showing a specific example of the proof tree generation processing according to Embodiment 1;

FIG. 7A is a diagram showing a specific example of the proof tree generation processing according to Embodiment 1;

FIG. 7B is a diagram showing a specific example of the proof tree generation processing according to Embodiment 1;

FIG. 8 is a flowchart showing an example of translation processing executed by a translation unit according to Embodiment 1;

FIG. 9 is a diagram showing a specific example of the translation processing according to Embodiment 1;

FIG. 10 is a flowchart showing an example of text output processing executed by a text output unit according to Embodiment 1;

FIG. 11 is a diagram showing a specific example of the text output processing according to Embodiment 1;

FIG. 12 is a flowchart showing an example of proof tree generation processing executed by a proof tree generation unit according to Embodiment 2;

FIG. 13 is a diagram showing an example of a screen presented by a computer according to Embodiment 2;

FIG. 14 is a diagram showing an example of the screen presented by the computer according to Embodiment 2;

FIG. 15 is a diagram showing an example of the screen presented by the computer according to Embodiment 2;

FIG. 16 is a diagram showing an example of conversion information held by the computer according to Embodiment 2;

FIG. 17 is a diagram showing an example of an inference in a decision-making problem; and

FIG. 18 is a diagram showing an example of an argument in logic.

### DESCRIPTION OF EMBODIMENTS

Hereinafter, embodiments of the invention will be described with reference to the drawings. However, the invention is not to be construed as being limited to the contents described in the embodiments to be described later. It will be easily understood by those skilled in the art that a specific configuration can be changed without departing from the spirit or scope of the invention.

In the configurations of the invention to be described later, the same or similar configurations or functions are denoted by the same reference numerals, and redundant descriptions will be omitted.

Notations “first”, “second”, “third”, and the like in the present specification are provided to identify components, and do not necessarily limit the number or an order of those components.

### Embodiment 1

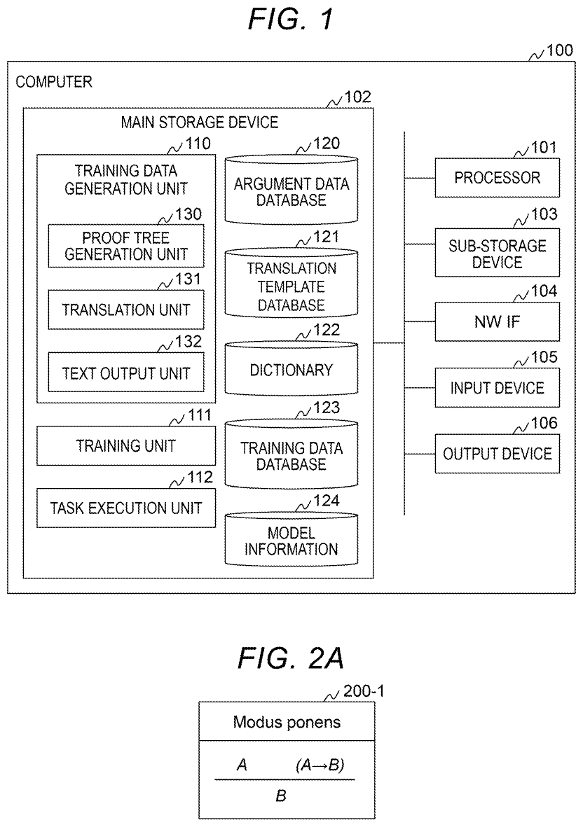

FIG. 1 is a diagram showing an example of a configuration of a computer 100 according to Embodiment 1.

The computer 100 generates a text representing a proof in which a non-biased argument is repeated a plurality of times, and generates training data using the text. The text includes a plurality of sentences. The computer 100 trains a model using the training data and executes a task using the model. A model trained using a natural language is called a language model. The invention is not limited to a content of a task to be executed and a type of the model.

The computer 100 includes a processor 101, a main storage device 102, a sub-storage device 103, a network interface 104, an input device 105, and an output device 106.

The processor 101 executes a program stored in the main storage device 102. The processor 101 executes processing according to the program, thereby operating as a functional unit (module) that implements a specific function. In the following description, when the processing is described with the functional unit as a subject, it is indicated that the processor 101 executes the program for implementing the functional unit.

The main storage device 102 is a memory and stores the program executed by the processor 101 and data used by the program. Further, the main storage device 102 is also used as a work area. The sub-storage device 103 is a hard disk drive (HDD), a solid state drive (SSD), or the like, and permanently stores data.

The program and the data may be stored in the sub-storage device 103. The processor 101 reads the program and the data from the sub-storage device 103 and loads the program and the data into the main storage device 102.

The network interface 104 performs communication via a network. The input device 105 is a keyboard, a mouse, a touch panel, or the like, and inputs data, commands, and the like to the computer 100. The output device 106 is a display or the like, and outputs data such as a processing result.

The main storage device 102 stores programs for implementing a training data generation unit 110, a training unit 111, and a task execution unit 112. The main storage device 102 stores an argument data database 120, a translation template database 121, a dictionary 122, a training data database 123, and model information 124.

The argument data database 120 is a database for managing data representing an argument (argument data). The argument represents an operation of leading to a conclusion proposition from a premise proposition. The proposition is expressed as a logical expression described using only proposition variables or a proposition variable and a logical symbol. The argument is described using an inference rule for leading to the conclusion proposition from the premise proposition.

The translation template database 121 is a database for managing a translation template for converting a logical expression into a language expression. In the following description, converting the logical expression into the language expression is referred to as “translation of the logical expression”.

The dictionary 122 is information for converting the proposition variable included in the logical expression into a character string such as a noun.

The training data database 123 is a database for managing the training data. The model information 124 is information on the model that performs a logical inference and is generated by training processing using the training data. The model is, for example, a neural network.

The training unit 111 performs the training processing using the training data. The invention is not limited to a method of the training processing. The task execution unit 112 executes any task using the model stored in the model information 124.

The training data generation unit 110 generates the training data using the argument data. The training data generation unit 110 includes a proof tree generation unit 130, a translation unit 131, and a text output unit 132. The proof tree generation unit 130 generates tree structure data (proof tree) representing a proof that leads to the conclusion by repeating the argument a plurality of times using the argument data. The translation unit 131 uses the translation template database 121 to translate the logical expression in the proof. The text output unit 132 generates the training data using the translated proof tree.

Regarding functional units in the computer 100, a plurality of functional units may be integrated into one functional unit, or one functional unit may be divided into a plurality of functional units for each function.

The computer 100 may not include the training unit 111 and the task execution unit 112.

The same function may be implemented by a computer system including a plurality of computers 100. In this case, the functional units may be distributed to the plurality of computers 100.

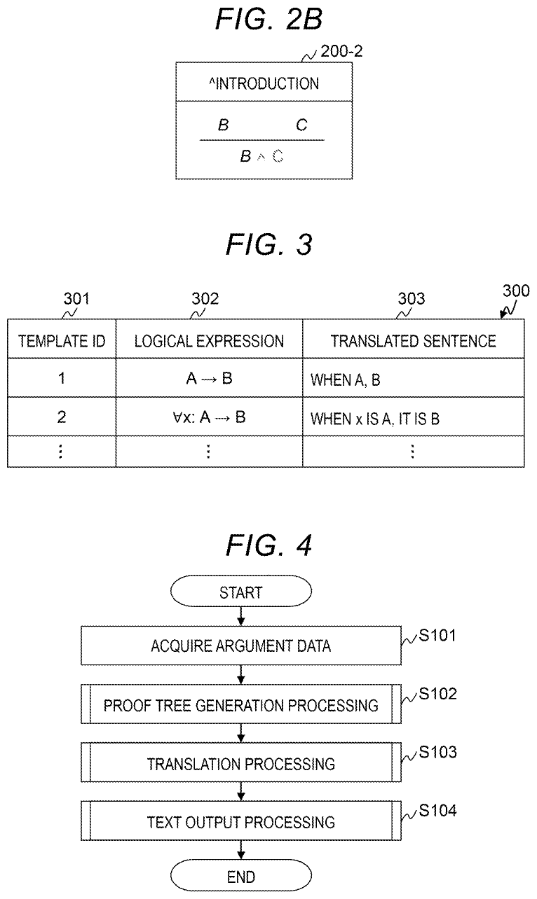

FIGS. 2A and 2B are diagrams showing examples of the argument data stored in the argument data database 120 according to Embodiment 1.

The argument data database 120 stores argument data 200-1 and 200-2 representing arguments as shown in FIGS. 2A and 2B. The argument data 200-1 represents an argument in which a proposition A and a proposition (when A, B) are used as premises. Here, A and B represent the proposition variables. A proposition on an upper side of a bar represents the premise proposition, and a proposition on a lower side of the bar represents the conclusion proposition. The bar is referred to as a premise bar.

The proposition variable of the argument data is given syntactic characteristics such as parts of speech and a conjugation form.

FIG. 3 is a diagram showing an example of the translation template database 121 according to Embodiment 1.

The translation template database 121 stores, for example, a table 300. The table 300 stores entries including a template ID 301, a logical expression 302, and a translated sentence 303. The template ID 301 is a field for storing an ID for identifying a translation type (template). The logical expression 302 is a field for storing the logical expression including logical symbols. The translated sentence 303 is a field for storing a sentence in which the logical expression including the logical symbols is expressed in a language.

A plurality of sentences may be defined for the logical expression of the same format. In this case, the sentences may be selected based on a random or any selection rule.

FIG. 4 is a flowchart showing an example of training data generation processing executed by the computer 100 according to Embodiment 1.

The computer 100 acquires a plurality of pieces of argument data from the argument data database 120 (step S101). All pieces of the argument data stored in the argument data database 120 may be acquired, or a predetermined number of pieces of the argument data may be acquired. When the predetermined number of pieces of the argument data are acquired, the pieces of the argument data may be randomly selected, or a user may designate the acquired pieces of the argument data.

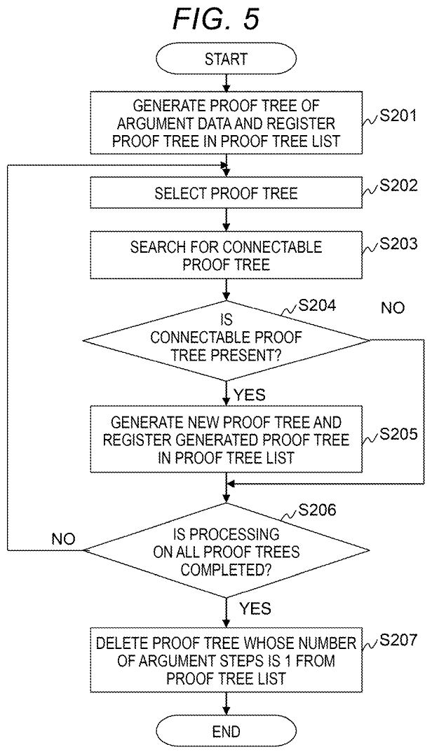

The proof tree generation unit 130 of the computer 100 executes proof tree generation processing (step S102). Details of the proof tree generation processing will be described with reference to FIG. 5.

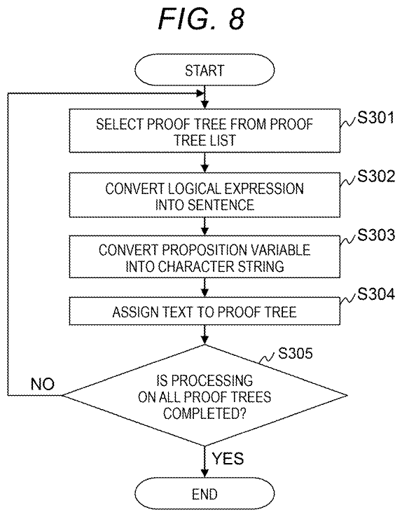

The translation unit 131 of the computer 100 executes translation processing (step S103). Details of the translation processing will be described with reference to FIG. 8.

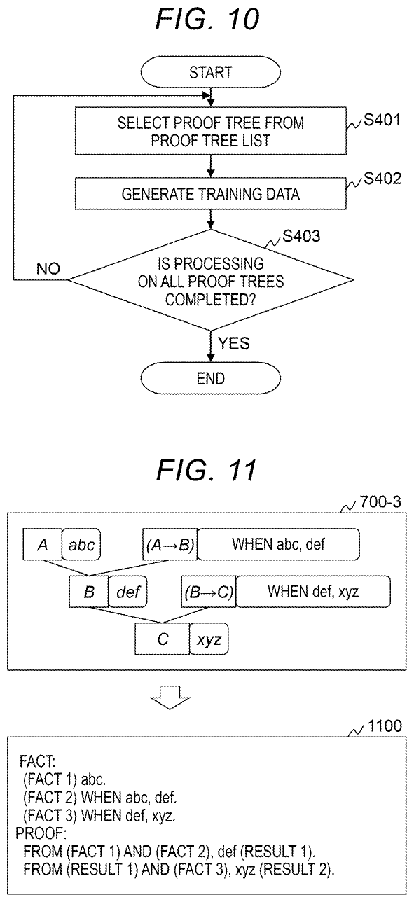

The text output unit 132 of the computer 100 executes text output processing (step S104). Details of the text output processing will be described with reference to FIG. 10.

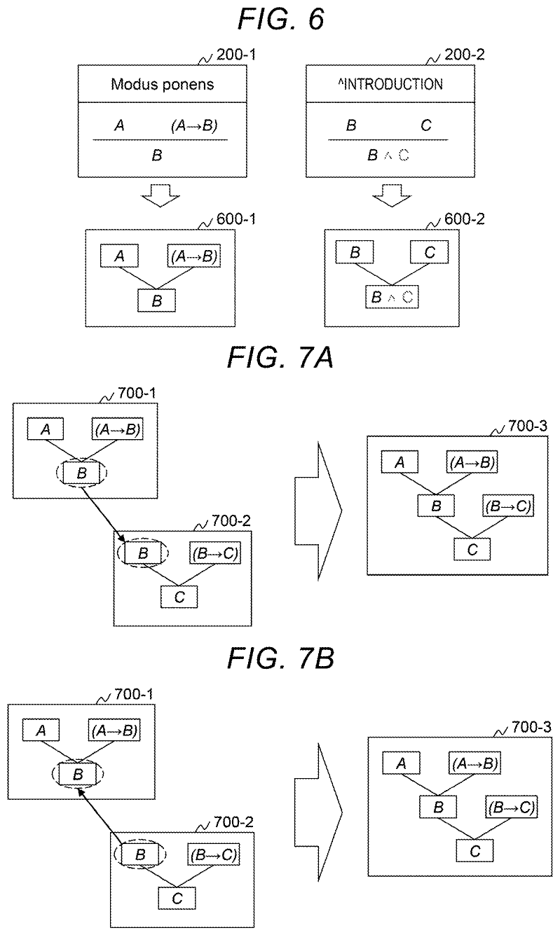

FIG. 5 is a flowchart showing an example of the proof tree generation processing executed by the proof tree generation unit 130 according to Embodiment 1. FIGS. 6, 7A, and 7B are diagrams showing specific examples of the proof tree generation processing according to Embodiment 1.

The proof tree generation unit 130 generates a proof tree for each of the plurality pieces of argument data, and registers the proof tree in the proof tree list (step S201).

Specifically, the proof tree generation unit 130 generates the tree structure data (proof tree) in which the premise proposition is a leaf node and the conclusion proposition is a root node. Further, the proof tree generation unit 130 assigns an unprocessed flag to each proof tree, and registers the proof tree to which the unprocessed flag is assigned in the proof tree list.

For example, as shown in FIG. 6, a proof tree 600-1 is generated from the argument data 200-1, and a proof tree 600-2 is generated from the argument data 200-2.

The proof tree generation unit 130 refers to the proof tree list to select one proof tree from the proof trees to which the unprocessed flags are assigned (step S202). Here, the selected proof tree is referred to as a target proof tree.

The proof tree generation unit 130 refers to the proof tree list to search for a proof tree connectable to the target proof tree (step S203).

Examples of a search method include a method (search method 1) of searching for a proof tree whose leaf node is the root node of the target proof tree, and a method (search method 2) of searching for a proof tree whose root node is the leaf node of the target proof tree. When the search method 2 is adopted, a search is performed for each leaf node of the target proof tree.

The proof tree generation unit 130 determines whether the proof tree connectable to the target proof tree is present as a result of the search (step S204).

When there is no proof tree connectable to the target proof tree, the proof tree generation unit 130 assigns a processed flag to the target proof tree, and the processing proceeds to step S206.

When the proof tree connectable to the target proof tree is present, the proof tree generation unit 130 generates a new proof tree by connecting the found proof tree to the target proof tree, assigns the unprocessed flag to the proof tree, and registers the new proof tree to which the unprocessed flag is assigned in the proof tree list (step S205). Thereafter, the proof tree generation unit 130 proceeds to step S206. At this time, the proof tree generation unit 130 adds the processed flag to the target proof tree.

As shown in FIG. 7A, when a search is performed by the search method 1 using a proof tree 700-1 as the target proof tree, a proof tree 700-2 is found. In this case, by combining a proposition B of the proof tree 700-1 and the proposition B of the proof tree 700-2, a proof tree 700-3 is generated.

As shown in FIG. 7B, when a search is performed by the search method 2 using the proof tree 700-2 as the target proof tree, the proof tree 700-1 is found. In this case, by combining the proposition B of the proof tree 700-2 and the proposition B of the proof tree 700-1, the proof tree 700-3 is generated.

When the search method 1 is adopted, new proof trees are generated by the number of found proof trees. When the search method 2 is adopted, new proof trees are generated by the number of combinations of the proof tree connectable to each leaf node.

The proof tree generation unit 130 determines whether the processing is completed for all the proof trees in the proof tree list (step S206).

Specifically, the proof tree generation unit 130 determines whether the processed flags are assigned to all the proof trees in the proof tree list. When the processed flags are assigned to all the proof trees in the proof tree list, the proof tree generation unit 130 determines that the processing is completed for all the proof trees in the proof tree list.

When the processing is not completed for all the proof trees in the proof tree list, the proof tree generation unit 130 returns to step S202.

When the processing is completed for all the proof trees in the proof tree list, the proof tree generation unit 130 deletes a proof tree whose number of argument steps is 1 from the proof tree list (step S207), and ends the proof tree generation processing. That is, the proof tree corresponding to the argument data is deleted.

According to the processing described above, a proof tree is generated, which corresponds to the proof that leads to the conclusion by repeating the arguments a plurality of times.

The proof tree generation processing described with reference to FIG. 5 is an example, and the invention is not limited thereto. Any processing may be used as long as the processing searches for an argument whose conclusion is a premise proposition of an argument and an argument whose premise is a conclusion proposition of the argument, and combines the arguments.

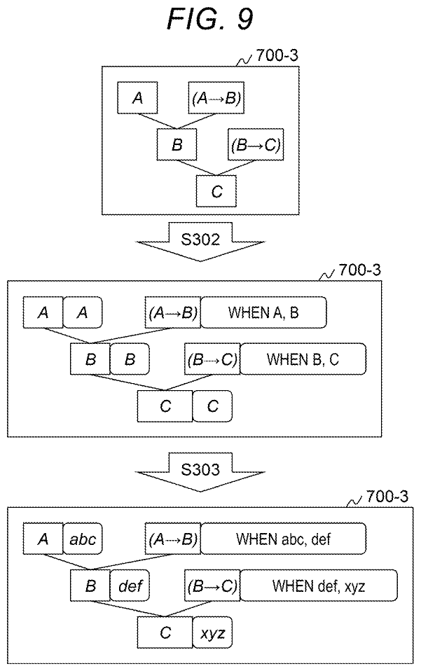

FIG. 8 is a flowchart showing an example of the translation processing executed by the translation unit 131 according to Embodiment 1. FIG. 9 is a diagram showing a specific example of the translation processing according to Embodiment 1.

The translation unit 131 selects one proof tree from the proof tree list (step S301). Here, the selected proof tree is referred to as the target proof tree.

The translation unit 131 refers to the translation template database 121 to convert the logical expressions included in the target proof tree into the sentences (step S302). Specifically, the following processing is executed.

(S302-1) The translation unit 131 selects one logical expression included in the target proof tree.

(S302-2) The translation unit 131 determines whether the selected logical expression is a logical expression including only the proposition variables.

(S302-3) When the selected logical expression is the logical expression including only the proposition variables, the translation unit 131 outputs the proposition variables as the sentences, and proceeds to S302-5.

(S302-4) When the selected logical expression is not the logical expression including only the proposition variables, the translation unit 131 searches the logical expression 302 for an entry in which the selected logical expression is stored. The translation unit 131 converts the selected logical expression into the sentence based on the translated sentence 303 of the found entry.

(S302-5) The translation unit 131 determines whether the processing is completed for all the logical expressions of the target proof tree. When the processing is not completed for all the logical expressions of the target proof tree, the translation unit 131 returns to S302-1. When the processing is completed for all the logical expressions of the target proof tree, the translation unit 131 ends the processing of step S302.

For example, when the proof tree 700-3 is selected as the target proof tree, an output as shown in FIG. 9 is obtained.

The translation unit 131 converts the proposition variables included in the sentence into character strings using the dictionary 122 (step S303).

For example, when the sentence is “when x is A, it is B”, the translation unit 131 converts “x”, “A”, and “B” into character strings, and generates a sentence “if the apple is red, it is delicious”. A plurality of sentences having different meanings may be generated from one sentence.

The translation unit 131 assigns the text to the target proof tree (step S304).

Specifically, as shown in FIG. 9, the translation unit 131 assigns the sentence to each node of the proof tree 700-3.

The translation unit 131 determines whether the processing is completed for all the proof trees (step S305).

When the processing is not completed for all the proof trees, the translation unit 131 returns to step S301. When the processing is completed for all the proof trees, the translation unit 131 ends the translation processing.

FIG. 10 is a flowchart showing an example of the text output processing executed by the text output unit 132 according to Embodiment 1. FIG. 11 is a diagram showing a specific example of the text output processing according to Embodiment 1.

The text output unit 132 selects one proof tree from the proof tree list (step S401). Here, the selected proof tree is referred to as the target proof tree.

The text output unit 132 generates the training data based on the text of the target proof tree (step S402).

Specifically, the text output unit 132 generates, based on a preset rule, the training data by outputting the sentence assigned to the node of the target proof tree. An output rule of the sentence can be changed according to the task executed by the task execution unit 112.

For example, when the task execution unit 112 executes a task for leading to a conclusion using the premise proposition as an input, a sentence of a node corresponding to the premise proposition is output as a sentence to be input to the model, and a sentence of a node corresponding to the conclusion proposition is output as a sentence to be output by the model.

The text output unit 132 may access an external database to check whether contents of the sentence are correct. When the contents of the sentence are not correct, the text output unit 132 performs control not to output the sentence as a sentence to be included in the training data.

An ID of the node may be output together with the sentence.

The training data generation unit 110 according to Embodiment 1 generates a proof tree representing the proof that leads to the conclusion by repeating the argument a plurality of time, converts the proof tree into text, and generates the training data from the text. Since the search for the connectable proof tree is comprehensively performed, it is possible to generate a proof in which the non-biased argument is repeated a plurality of times. In addition, it is possible to generate a proof based on a complex combination of arguments. By generating the training data using the text representing the proofs, the training data for simulating the logical inference can be generated. A model having a logical inference ability can be generated by the training processing using the generated training data.

### Embodiment 2

Embodiment 2 differs from Embodiment 1 in proof tree generation processing. Hereinafter, Embodiment 2 will be described focusing on differences from Embodiment 1.

A hardware configuration and a software configuration of the computer 100 according to Embodiment 2 are the same as those according to Embodiment 1. A flow of training data generation processing according to Embodiment 2 is the same as that according to Embodiment 1. Translation processing and text output processing according to Embodiment 2 are the same as those according to Embodiment 1.

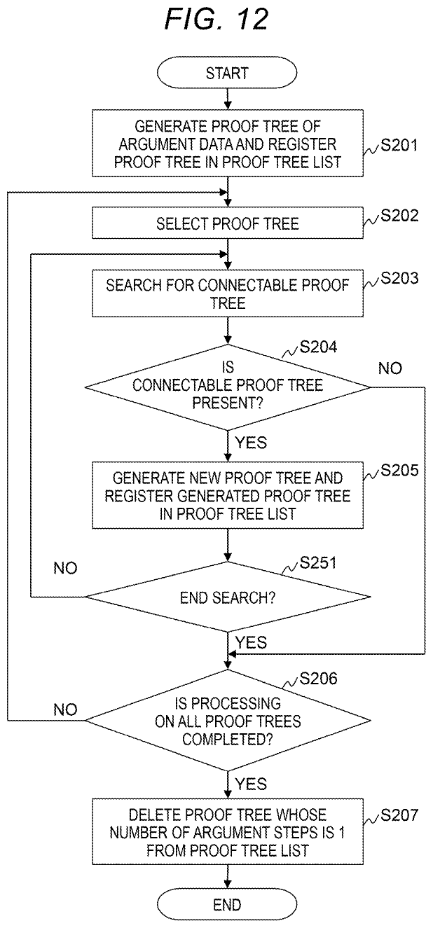

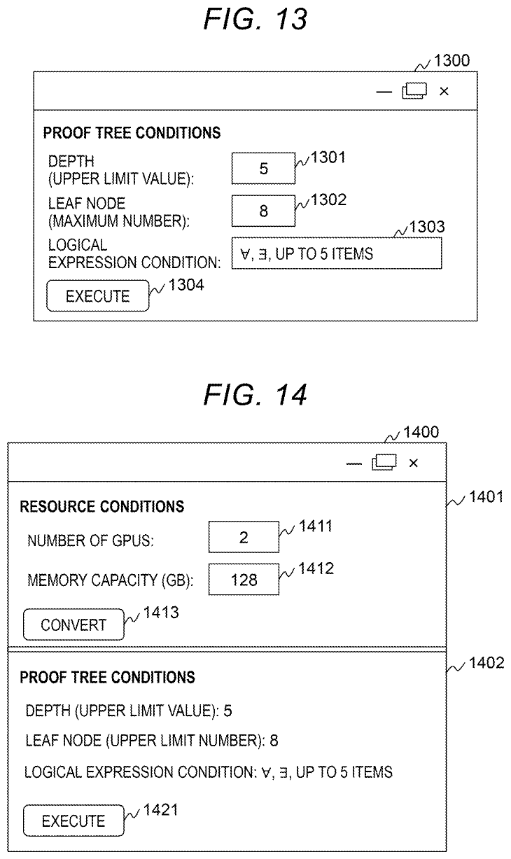

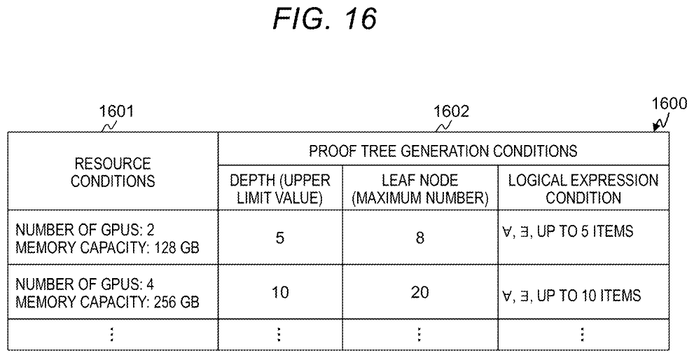

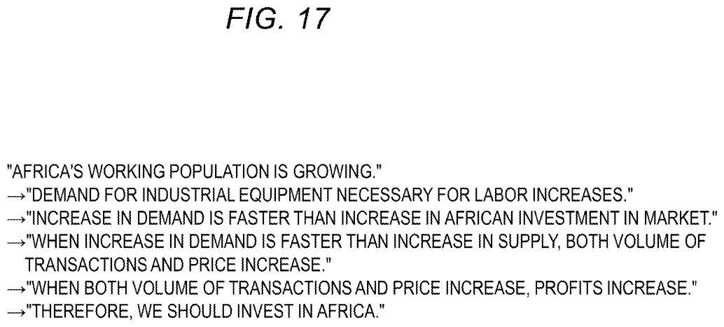

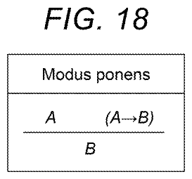

FIG. 12 is a flowchart showing an example of the proof tree generation processing executed by the proof tree generation unit 130 according to Embodiment 2. FIGS. 13, 14, and 15 are diagrams showing examples of screens presented by the computer 100 according to Embodiment 2. FIG. 16 is a diagram showing an example of conversion information 1600 held by the computer 100 according to Embodiment 2.

The computer 100 according to Embodiment 2 receives an input for determining conditions of a proof tree to be generated (proof tree generation conditions) when executing the training data generation processing.

A screen 1300 is a screen for inputting the proof tree generation conditions, and includes input fields 1301, 1302, and 1303 and an execution button 1304. The user determines the proof tree generation conditions based on a resource of the computer 100 or the proof tree handled in the task, and inputs information to the screen 1300.

The input field 1301 is a field for inputting an upper limit value of a depth of the proof tree. The input field 1302 is a field for inputting an upper limit value of the leaf nodes included in the proof tree. The input field 1303 is a field for inputting a condition of the logical expression. The execution button 1304 is an operation button for instructing execution of the training data generation processing.

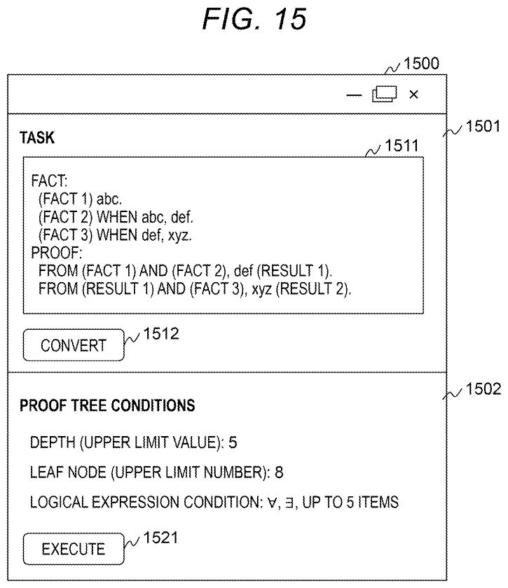

It may be difficult for the user to determine the proof tree generation conditions. In this case, screens 1400 and 1500 as shown in FIGS. 14 and 15 are presented.

The screen 1400 is a screen for setting the proof tree generation conditions based on conditions related to a resource amount of the computer 100. The screen 1400 includes an input area 1401 and a display area 1402. The input area 1401 is an area for inputting the conditions related to the resource amount. The display area 1402 is an area for displaying the proof tree generation conditions.

The input area 1401 includes input fields 1411 and 1412 and a conversion button 1413. The input field 1411 is a field for inputting the number of GPUs. The input field 1412 is a field for inputting capacity of a memory. The conversion button 1413 is an operation button for instructing conversion from information conditions related to the resource amount to the proof tree generation conditions.

The computer 100 holds the conversion information 1600 as shown in FIG. 16. The conversion information 1600 stores entries including a resource condition 1601 and a proof tree generation condition 1602. When the conversion button 1413 is operated, the computer 100 refers to the conversion information 1600 to search for an entry in which the resource condition 1601 matches the resource condition input to the input area 1401. The computer 100 displays the proof tree generation conditions in the display area 1402 based on the proof tree generation condition 1602 of the found entry. The user corrects the proof tree generation conditions displayed in the display area 1402 as necessary. Further, the user operates the execution button 1421 in the display area 1402 to instruct the execution of the training data generation processing.

The screen 1500 is a screen for setting the proof tree generation conditions based on data of a logical inference handled in a task. The screen 1500 includes an input area 1501 and a display area 1502. The input area 1501 is an area for inputting the data of the logical inference handled in the task. The display area 1502 is an area for displaying the proof tree generation conditions.

The input area 1501 includes an input field 1511 and a conversion button 1512. The input field 1411 is a field for inputting the data of the logical inference handled in the task. The conversion button 1512 is an operation button for instructing conversion from the data of the logical inference handled in the task to the proof tree generation conditions.

When the conversion button 1512 is operated, the computer 100 converts the data of the logical inference into the proof tree, and analyzes the proof tree obtained by the conversion to determine the proof tree generation conditions. Examples of a method of converting the data of the logical inference into the proof tree include a known syntactic analysis/argumentation mining technique. Alternatively, a method using a rule-based converter may be used. Items of the proof tree generation conditions that cannot be determined based on the data of the logical inference are randomly determined.

The computer 100 displays the proof tree generation conditions in the display area 1502. The user corrects the proof tree generation conditions displayed in the display area 1502 as necessary. Further, the user operates the execution button 1521 in the display area 1502 to instruct the execution of the training data generation processing.

The proof tree generation processing according to Embodiment 2 will be described.

Processing of steps S201 to S203 is the same as that according to Embodiment 1. In step S203, a connectable proof tree is searched for based on the proof tree generation conditions. Processing of steps S204 and S205 is the same as that according to Embodiment 1.

After the processing of step S205, the proof tree generation unit 130 determines whether to end the search based on the proof tree generation conditions (step S251). For example, it is determined to end the search when a depth of a newly generated proof tree matches the upper limit value.

When the search is not ended, the proof tree generation unit 130 returns to step S203. When the search is ended, the proof tree generation unit 130 proceeds to step S206.

According to Embodiment 2, the proof tree desired by the user can be generated. Accordingly, it is expected to reduce a load, shorten a calculation time, and improve accuracy of a model.

The invention is not limited to the embodiments described above, and includes various modifications. For example, the configurations in the embodiments described above have been described in detail to facilitate understanding of the invention, and the invention is not necessarily limited to those including all the configurations described above. A part of a configuration in each embodiment may be added to, deleted from, or replaced with another configuration.

A part or all of the configurations, functions, processing units, processing methods, and the like described above may be implemented by hardware by, for example, designing with an integrated circuit. The invention can also be implemented by a program code of software for implementing the functions in the embodiments. In this case, a storage medium storing the program code is provided to a computer, and a processor provided in the computer reads the program code stored in the storage medium. In this case, the program code read from the storage medium implements the functions of the embodiments described above by itself, and the program code itself and the storage medium storing the program code constitute the invention. Examples of the storage medium for supplying such a program code include a flexible disk, a CD-ROM, a DVD-ROM, a hard disk, a solid state drive (SSD), an optical disk, a magneto-optical disk, a CD-R, a magnetic tape, a nonvolatile memory card, and a ROM.

Further, the program code for implementing the functions described in the embodiments can be implemented in a wide range of programs or script languages such as Assembler, C/C++, Perl, Shell, PHP, Python, and Java (registered trademark).

Further, the program code of the software for implementing the functions in the embodiments may be distributed via a network to be stored in a storage unit such as a hard disk or a memory of a computer or a storage medium such as a CD-RW or a CD-R, and a processor provided in the computer may read and execute the program code stored in the storage unit or the storage medium.

Control lines and information lines indicate what is considered to be necessary for explanation, and not necessarily all control lines and information lines are always shown on the product. All the configurations may be connected to one another.

What is claimed is:

1. A computer system for generating training data used for training a model configured to perform a logical inference, the computer system comprising:
at least one computer, wherein
the computer system holds argument data representing an argument that leads to a conclusion proposition from a plurality of premise propositions,
the proposition is expressed as a logical expression, and
the at least one computer
searches for the argument data whose conclusion is the premise proposition of the argument data or the argument data whose premise is the conclusion proposition of the argument data and performs combination to generate proof data representing a proof that leads to a conclusion proposition by repeating the argument a plurality of times,
converts the proof data into a text expressed as a language expression, and
generates the training data using the text.

2. The computer system according to claim 1, wherein
the at least one computer
generates, using the argument data, a proof tree that is tree structure data whose leaf node is the premise proposition and root node is the conclusion proposition,
searches for, using the proof tree, the argument data whose conclusion is the premise proposition of the argument data or the argument data whose premise is the conclusion proposition of the argument data, and
generates the proof data by combining a plurality of the proof trees based on a result of the search.

3. The computer system according to claim 2, wherein
the logical expression is described using a variable representing a proposition, or the variable and a logical symbol,
the computer system manages a template in which a logical expression including the logical symbol is associated with a sentence, and
the at least one computer
outputs the variable of the logical expression including only the variable of the proof data as a sentence,
converts the logical expression including the logical symbol of the proof data into a sentence using the template,
converts the variable included in the sentence obtained by converting the logical expression into a character string, and
generates the text including sentences obtained by converting a plurality of the logical expressions included in the proof data.

4. The computer system according to claim 2, wherein
the at least one computer
receives a generation condition of the proof data from a user, and
generates the proof data based on the generation condition of the proof data.

5. The computer system according to claim 4, wherein
the at least one computer
receives information related to a resource amount of the computer system from the user,
determines the generation condition of the proof data based on the resource amount of the computer system, and
presents the determined generation condition of the proof data.

6. The computer system according to claim 4, wherein
the at least one computer
receives, from the user, information related to data handled by the model trained using the training data,
analyzes the data handled by the model trained using the training data,
determines the generation condition of the proof data based on a result of the analysis, and
presents the determined generation condition of the proof data.

7. The computer system according to claim 2, wherein
at least one of training processing of generating the model configured to execute any task using the training data and task execution processing using the model is executed.

8. A method for generating training data used for training a model configured to perform a logical inference, the method being executed by a computer system,
the computer system including at least one computer,
the computer system holding argument data representing an argument that leads to a conclusion proposition from a plurality of premise propositions,
the proposition being expressed as a logical expression,
the method comprising:
a first step of searching for, by the at least one computer, the argument data whose conclusion is the premise proposition of the argument data or the argument data whose premise is the conclusion proposition of the argument data and performing combination to generate proof data representing a proof that leads to a conclusion proposition by repeating the argument a plurality of times;
a second step of converting, by the at least one computer, the proof data into a text expressed as a language expression; and
a third step of generating, by the at least one computer, the training data using the text.

9. The method for generating training data according to claim 8, wherein
the first step includes:
a step of generating, by the at least one computer, using the argument data, a proof tree that is tree structure data whose leaf node is the premise proposition and root node is the conclusion proposition;
a step of searching for, by the at least one computer, using the proof tree, the argument data whose conclusion is the premise proposition of the argument data or the argument data whose premise is the conclusion proposition of the argument data; and
a step of generating, by the at least one computer, the proof data by combining a plurality of the proof trees based on a result of the search.

10. The method for generating training data according to claim 9, wherein
the logical expression is described using a variable representing a proposition, or the variable and a logical symbol,
the computer system manages a template in which a logical expression including the logical symbol is associated with a sentence, and
the second step includes:
a step of outputting, by the at least one computer, the variable of the logical expression including only the variable of the proof data as a sentence;
a step of converting, by the at least one computer, the logical expression including the logical symbol of the proof data into a sentence using the template;
a step of converting, by the at least one computer, the variable included in the sentence obtained by converting the logical expression into a character string; and
a step of generating, by the at least one computer, the text including sentences obtained by converting a plurality of the logical expressions included in the proof data.

11. The method for generating training data according to claim 9, further comprising:
a step of receiving, by the at least one computer, a generation condition of the proof data from a user; and
a step of generating, by the at least one computer, the proof data based on the generation condition of the proof data.

12. The method for generating training data according to claim 11, further comprising:
step of receiving, by the at least one computer, information related to a resource amount of the computer system from the user;
a step of determining, by the at least one computer, the generation condition of the proof data based on the resource amount of the computer system; and
a step of presenting, by the at least one computer, the determined generation condition of the proof data.

13. The method for generating training data according to claim 11, further comprising:
a step of receiving, by the at least one computer, from the user, information related to data handled by the model trained using the training data;
a step of analyzing, by the at least one computer, the data handled by the model trained using the training data;
a step of determining, by the at least one computer, the generation condition of the proof data based on a result of the analysis; and
a step of presenting, by the at least one computer, the determined generation condition of the proof data.

14. The method for generating training data according to claim 9, further comprising:
a step of executing, by the at least one computer, at least one of training processing of generating the model configured to execute any task using the training data and task execution processing using the model.
